(19) United States
(12) Patent Application Publication
(10) Pub. No.: US 2013/0257836 A1
(43) Pub. Date: Oct. 3, 2013

(54) DISPLAY DEVICE WITH SCAN DRIVER

(71) Applicant: ILI TECHNOLOGY CORPORATION, Jhubei City (TW)

(72) Inventors: Hung-Cheng Chen, Hsinchu City (TW); Chien-Kuo Wang, Hsinchu City (TW); Liang-Jung Chen, Zhubei City (TW)

(73) Assignee: ILI TECHNOLOGY CORPORATION, Jhubei City (TW)

(21) Appl. No.: 13/756,396

(22) Filed: Jan. 31, 2013

(30) Foreign Application Priority Data
Mar. 29, 2012 (TW) 101111110

(51) Int. Cl. G09G 5/00

(52) U.S. Cl. CPC G09G 5/001
USPC 345/208

(57) ABSTRACT

A display device includes a plurality of pixel circuits arranged in a plurality of rows and columns, a plurality of scan lines, a plurality of data lines, a scan driver operable to drive the rows of the pixel circuits in sequence via the scan lines, and a data driver coupled to the columns of the pixel circuits via the data lines. The scan lines include first and second sets of scan lines alternately disposed with each other. For each of the first and second sets of the scan lines, adjacent scan lines have different circuit properties. The scan driver activates each of the scan lines for a respective activation time period according to the circuit property thereof.

### CROSS-REFERENCE TO RELATED APPLICATION

This application claims priority to Taiwanese Application No. 101111110, filed on Mar. 29, 2012.

### BACKGROUND OF THE INVENTION

1. Field of the Invention

The invention relates to a display device, and more particularly to a display device with a scan driver.

2. Description of the Related Art

In a display device, pixel circuits arranged in a row are coupled to a scan driver via a scan line. Since a number of the scan lines is relatively large, considerable space must be reserved at two sides of the pixel circuits for disposing the scan lines, thus resulting in an increase in width of the display device.

A common solution to this problem is to route a portion of the scan lines in a first circuit layer, and to route another portion of the scan lines in a second circuit layer. Through use of a multilayer circuit design, the routing width in a single layer is reduced, thereby achieving a reduction in the width of the display device.

However, metals used in each circuit layer may not be the same, and distances between the scan driver and each pixel circuit row are different, resulting in different signal transmission times from the scan driver to the scan lines, and a horizontal line symptom may occur on a displayed image.

### SUMMARY OF THE INVENTION

Therefore, an object of the present invention is to provide a display device with a scan driver that is able to provide different activation time periods for scan lines to overcome the above drawback.

According to the present invention, a display device comprises:

a plurality of pixel circuits arranged in a plurality of rows and columns;

a plurality of scan lines, each coupled to a respective one of the rows of the pixel circuits;

a plurality of data lines, each coupled to a respective one of the columns of the pixel circuits;

a scan driver operable to activate the scan lines in sequence to drive the rows of the pixel circuits; and

a data driver coupled to the columns of the pixel circuits via the data lines;

wherein the scan lines include a first set of scan lines and a second set of scan lines alternately disposed with the first set of scan lines;

wherein, for each of the first and second sets of the scan lines, adjacent ones of the scan lines have different circuit properties;

wherein the scan driver activates each of the scan lines for a respective activation time period according to the circuit property thereof.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit diagram showing a preferred embodiment of the display device according to the present invention;

FIG. 2 is a schematic diagram illustrating an activation sequence for the scan lines of the preferred embodiment;

FIG. 3 is a schematic diagram illustrating an adjustment of the activation time periods in the preferred embodiment;

FIG. 4 is a schematic diagram illustrating another adjustment of the activation time periods in the preferred embodiment;

FIG. 5 is a schematic diagram showing a relationship between resistance compensation time periods and the scan lines; and

FIG. 6 is a schematic diagram showing a relationship between capacitance compensation time period and the scan lines.

### DETAILED DESCRIPTION OF THE PREFERRED EMBODIMENT

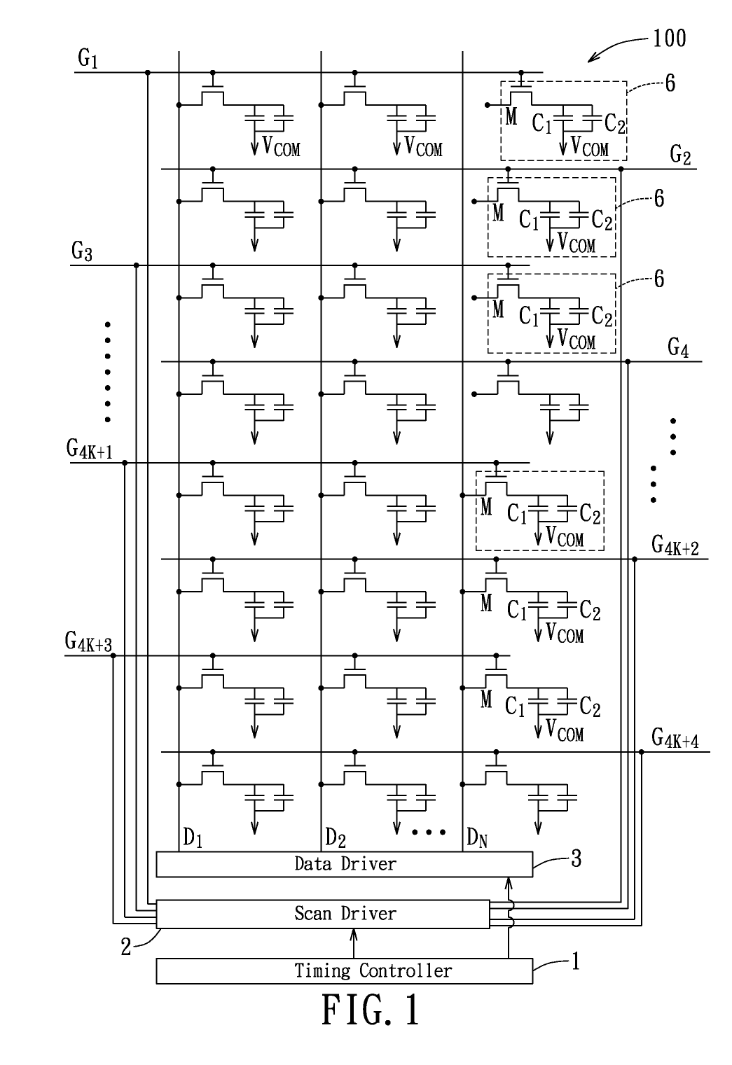

Referring to FIG. 1, the preferred embodiment of the display device 100 according to this invention is shown to comprise a timing controller 1, a scan driver 2, a data driver 3, and a plurality of pixel circuits 6 arranged in a plurality of rows and columns. In this embodiment, a number of the rows is denoted as M, and a number of the columns is denoted as N. The display device 100 further comprises M scan lines Gₘ, each coupled to a respective one of the rows of the pixel circuits 6, and N data lines Dₙ, each coupled to a respective one of the columns of the pixel circuits 6, where m=1˜M, n=1˜N, M=4K+4 , and K is a positive integer.

Each pixel circuit 6 includes a transistor M, a liquid crystal capacitor C₁, and a storage capacitor C₂ parallel to the liquid crystal capacitor C₁. The transistor M has a control terminal coupled to a corresponding scan line Gₘ, a first terminal coupled to a corresponding data line Dₙ, and a second terminal coupled to a terminal of the liquid crystal capacitor C₁. The other terminal of the liquid crystal capacitor C₁ is coupled to a common voltage source V_{COM}.

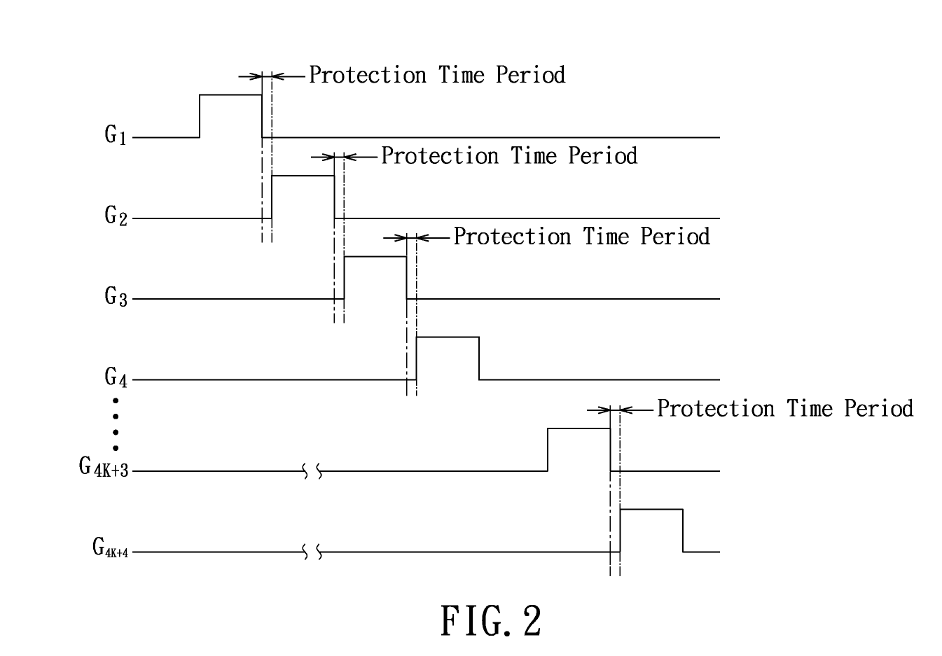

In the display device 100, the scan driver 2 is controlled by the timing controller 1 to activate the scan lines Gₘ in sequence to drive the rows of the pixel circuits 6, as shown in FIG. 2. When a scan line Gₘ is activated, the transistors M of the corresponding pixel circuits 6 conduct, and liquid crystal molecules (not shown) in the corresponding liquid crystal capacitor C₁ are twisted for an angle according to the coupled data line Dₙ, and the common voltage source V_{COM}, so as to determine a transmittance of the pixel circuit 6 to allow light from a backlight source (not shown) to pass therethrough. Before next activation, the corresponding storage capacitor C₂ preserves the voltage of the liquid crystal capacitor C₁ to keep the twisted angle of the liquid crystal molecules, such that the pixel circuit 6 keeps the desired luminance.

As shown in FIG. 1, the scan lines denoted by odd numbers are routed from the left side of the pixel circuits 6, and the scan lines denoted by even numbers are routed from the right side of the pixel circuits 6. In other words, the scan lines G₁, G₃, G₅ . . . , G_{4K+1}, and G_{4K+3} are coupled to the scan driver 2 from the left side of the corresponding rows of the pixel circuits 6 and the scan lines G₂, G₄, G₆ . . . , G_{4K+2} , and G_{4K+4} are coupled to the scan driver 2 from the right side of the corresponding rows of the pixel circuits 6. Therefore, width of the display device 100 is determined from both the number of the pixel circuits 6 and the number of the scan lines.

To reduce the width of the display device 100, this embodiment employs a multilayer circuit design to share the routes of the scan lines. The scan line G₄ₖ₊₁ coupled to the (4k+1)^{th} row of the pixel circuits 6 is routed on a first circuit layer (not shown), and the scan line G₄ₖ₊₃ coupled to the (4k+3)^{th} row of the pixel circuits 6 is routed on a second circuit layer (not shown). For the routes from the other side of the pixel circuits 6, the scan line G₄ₖ₊₂ coupled to the (4k+2)^{th} row of the pixel circuits 6 is routed on the first circuit layer, and the scan line G₄ₖ₊₄ coupled to the (4k+4)^{th} row of the pixel circuits 6 is routed on the second circuit layer. In the above description, k=0˜K.

However, the first and second circuit layers have different resistances, so that the waveform from activation of the scan line G₄ₖ₊₁ is different from that from activation of the scan line G₄ₖ₊₃. Since the route conditions of the two scan line sets (the odd number set and the even number set) are similar, the following description only uses the scan lines G₄ₖ₊₁ and G₄ₖ₊₃ for illustration.

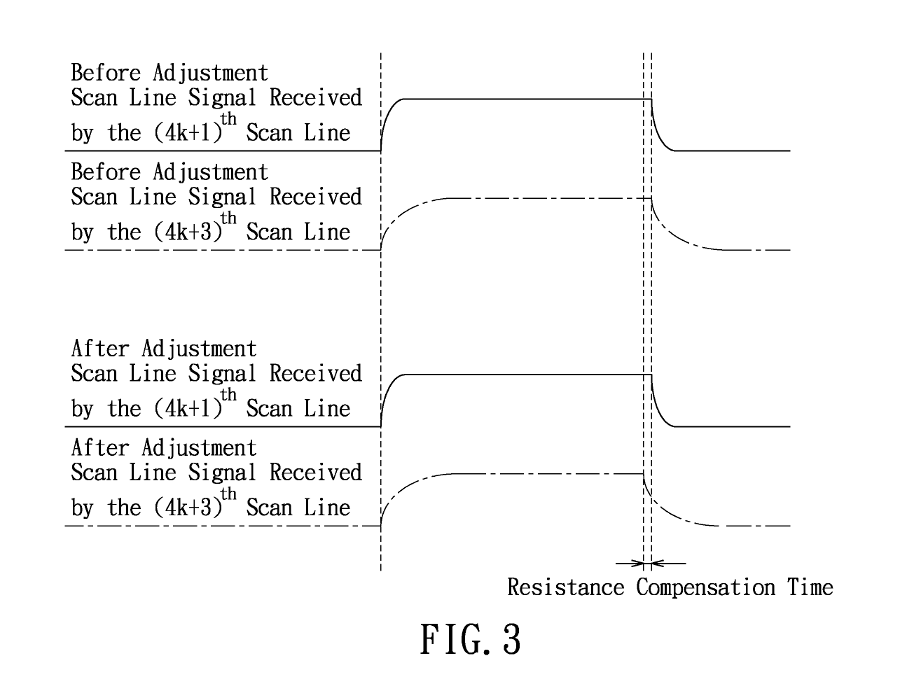

As shown in FIG. 3, assuming the resistance of the first circuit layer is smaller than that of the second circuit layer, when the scan line G₄ₖ₊₁ is activated, the waveform of the scan line signal received by the (4k+1)^{th} row of the pixel circuits 6 has a relatively sharper rising edge and falling edge than the waveform of the scan line signal received by the (4k+3)^{th} row of the pixel circuits 6 when the scan line G₄ₖ₊₃ is activated. Therefore, comparing the end points of activations of the scan lines, the voltage across the storage capacitor C₂ on the (4k+1)^{th}scan line falls more rapidly than that of the storage capacitor C₂ on the (4k+3)^{th} scan line, resulting in luminance difference between the two adjacent rows of the pixel circuits 6 of the same scan line set, and the horizontal line symptom thus occurs in the displayed image.

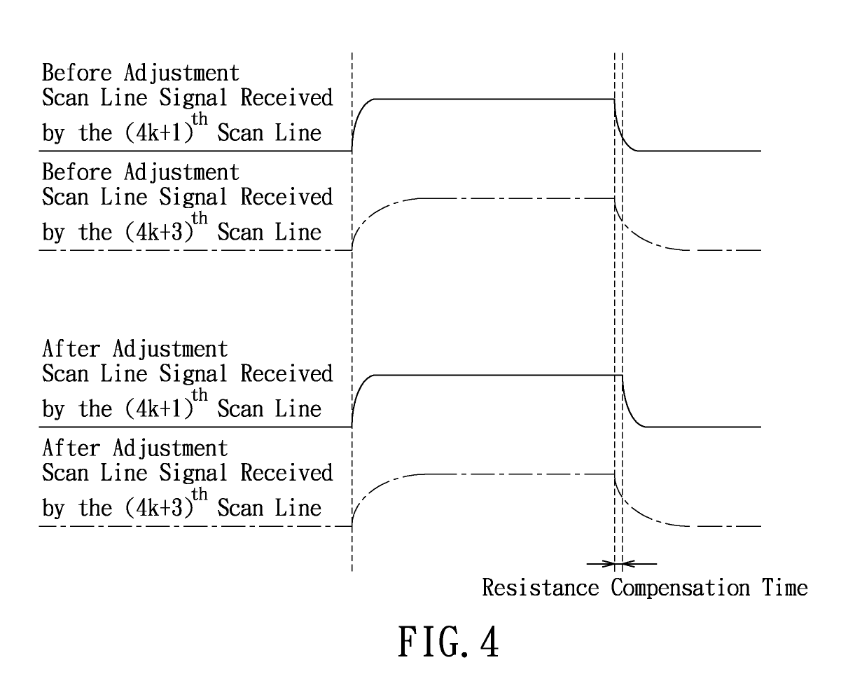

It should be noted that to facilitate comparison between activation time periods of the scan lines G₄ₖ₊₁ and G₄ₖ₊₃, the start points of the activation time periods of the scan lines G₄ₖ₊₁ and G₄ₖ₊₃ are aligned in FIGS. 3 and 4. In actual activation timing sequence, the activation time periods between any two scan lines are non-overlapping time periods, as shown in FIG. 2.

In this embodiment, the activation time period provided by the scan driver 2 for each scan line is adjustable. For each set of the scan lines, a length of time between start points of the activation time periods of any two adjacent ones of the scan lines is constant, and the end point of the scan line G₄ₖ₊₃ is adjusted so that the activation time period of the scan line G₄ₖ₊₃ is shorter than that of the scan line G₄ₖ₊₁ by a resistance compensation time period to alleviate the horizontal line symptom.

Referring to FIG. 3, in one implementation, the start points of the activation time periods for all the scan lines and the end points of the activation time periods for the scan lines on the circuit layer with a lower resistance are maintained, while the endpoints of the activation time periods for the scan lines on the circuit layer with a higher resistance are adjusted to be earlier. Referring to FIG. 4, in another implementation, the start points of the activation time periods for all the scan lines and the end points of the activation time periods for the scan lines on the circuit layer with the higher resistance are maintained, while the endpoints of the activation time periods for the scan lines on the circuit layer with the lower resistance are adjusted to be later. It should be noted that in FIG. 2, when activation of a scan line ends, activation of the next scan line starts later after a protection time period that is longer than the resistance compensation time period, so that in the implementations shown in FIGS. 3 and 4, the activation time periods of any two adjacent ones of the scan lines are non-overlapping time periods, and the liquid crystal molecules of the pixel circuits 6 in the same column but in two adjacent rows are not twisted by the data line Dₙ at the same time.

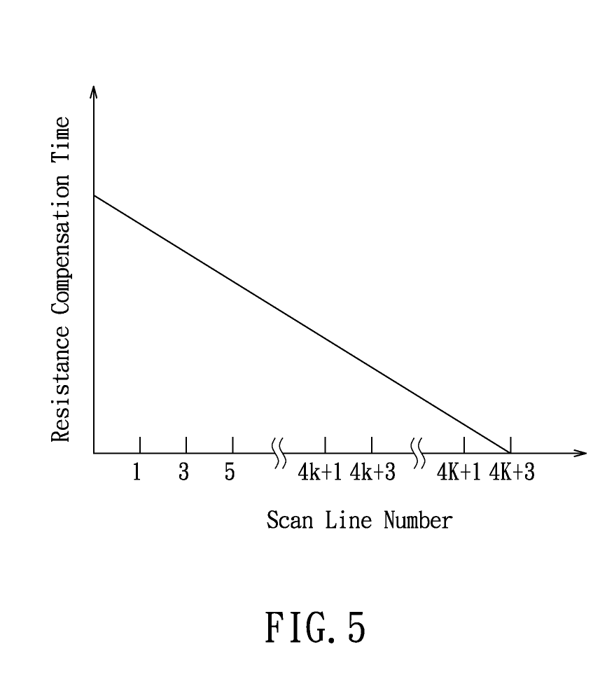

The scan driver 2 in FIG. 1 is spaced apart from the first row of the pixel circuits 6 and is close to the (4K+4)^{th} row of the pixel circuits 6, such that signal transmission time from the scan driver 2 to each scan line shortens with an increase of the scan line number. The resistance compensation time should be reduced with the increase of the scan line number. Preferably, the relationship between the resistance compensation time and the scan line number is a linear decrease as shown in FIG. 5, but in another application, it may be a logarithmic decrease or otherwise. The only requirement is that the resistance compensation time decreases with increase of the scan line number.

From the above description, people with general knowledge in the technical field of this invention should appreciate that when the resistance of the first circuit layer is greater than that of the second circuit layer, the start points of the activation time periods for all the scan lines are maintained, while the end points of the activation time periods for the scan lines G₄ₖ₊₁ should be adjusted to be earlier, such that the activation time period of the scan lines G₄ₖ₊₁ is shorter than that of the scan lines G₄ₖ₊₃.

The liquid crystal capacitors C₁ of all the pixel circuits 6 are coupled to a common voltage source V_{COM} on a third circuit layer (not shown). Since the first to the third circuit layers are very close to each other, there exists a capacitance effect. A first stray capacitor is formed between the first and the third circuit layers to have a first stray capacitance, and a second stray capacitor is formed between the second and the third circuit layers to have a second stray capacitance. Because a shorter distance between two layers results in greater stray capacitance, the first and second stray capacitance values are different to thereby cause luminance difference between two adjacent scan lines for each scan line set, and the horizontal line symptom occurs on the displayed image.

To solve this issue, if the first stray capacitance is smaller than the second stray capacitance, the scan driver 2 is adjusted to maintain the start points of the activation time periods of all the scan lines, and to adjust the end points of the scan line G₄ₖ₊₃ to be earlier, such that the activation time period of the scan line G₄ₖ₊₃ is longer than that of the scan line G₄ₖ₊₁ by a capacitance compensation time. On the other hands, if the first stray capacitance is greater than the second stray capacitance, the scan driver 2 is adjusted to maintain the start points of the activation time periods of all the scan lines, and to adjust the end points of the scan line G₄ₖ₊₁ to be earlier, such that the activation time period of the scan line G₄ₖ₊₃ is shorter than that of the scan line G₄ₖ₊₁ by a capacitance compensation time.

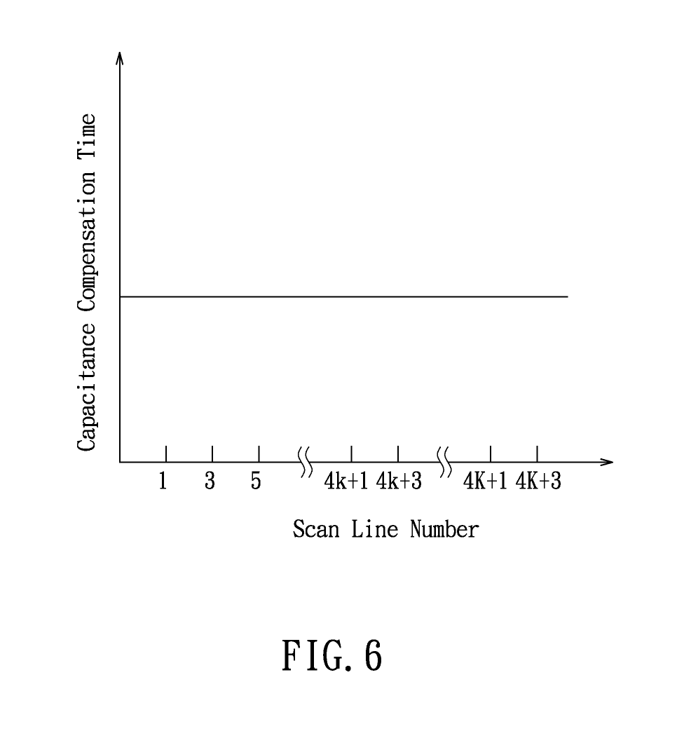

Since the stray capacitance only relates to the distance from the third circuit layer, and not to the distance between each row of the scan lines and the scan driver 2, the length of the capacitance compensation time period is not related to the scan line number, as shown in FIG. 6.

Regarding the routings at the right side of the pixel circuits 6, the scan lines G₄ₖ₊₂ can be routed on one of the first and second circuit layers, and the scan lines G₄ₖ₊₄ can be routed on the other layer. People with general knowledge in the technical field should be able to deduce how to adjust the activation time periods to alleviate the horizontal line symptom in light of the description provided hereinabove.

To sum up, in the preferred embodiment, the scan driver 2 is adjusted to provide different activation time periods according to the circuit properties of the first and second circuit layers, so as to minimize the luminance difference between two adjacent rows of the pixel circuits 6 for each scan line set to alleviate the horizontal line symptom on the displayed image.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display device comprising:
a plurality of pixel circuits arranged in a plurality of rows and columns;
a plurality of scan lines, each coupled to a respective one of said rows of said pixel circuits;
a plurality of data lines, each coupled to a respective one of said columns of said pixel circuits;
a scan driver operable to activate said scan lines in sequence to drive said rows of said pixel circuits; and
a data driver coupled to said columns of said pixel circuits via said data lines;
wherein said scan lines include a first set of scan lines and a second set of scan lines alternately disposed with said first set of scan lines;
wherein, for each of said first and second sets of said scan lines, adjacent ones of said scan lines have different circuit properties;
wherein said scan driver activates each of said scan lines for a respective activation time period according to the circuit property thereof.

2. The display device as claimed in claim 1, wherein, for each of said first and second sets of said scan lines,
one of said scan lines has an electrical resistance greater than that of another one of said scan lines adjacent thereto,
the activation time period of said one of said scan lines is shorter than that of said another one of said scan lines adjacent thereto by a resistance compensation time period, and
the activation time periods of any two of said scan lines are non-overlapping time periods.

3. The display device as claimed in claim 2, wherein, for each of said first and second sets of said scan lines, a length of time between start points of the activation time periods of any two adjacent ones of said scan lines is constant.

4. The display device as claimed in claim 2, wherein, for each of said first and second sets of said scan lines, the resistance compensation time period of said one of said scan lines increases with a distance thereof to said scan driver.

5. The display device as claimed in claim 1, further comprising a common voltage source,
each of said pixel circuits including a liquid crystal capacitor coupled to said common voltage source,
wherein, for each of said first and second sets of said scan lines,
one of said scan lines has a shorter distance to said common voltage source compared to that of another one of said scan lines adjacent thereto,
the activation time period of said one of said scan lines is shorter than that of said another one of said scan lines adjacent thereto by a capacitance compensation time period, and
the activation time periods of any two of said scan lines are non-overlapping time periods.

6. The display device as claimed in claim 5, wherein, for each of said first and second sets of said scan lines, a length of time between start points of the activation time periods of any two adjacent ones of said scan lines is constant.

7. The display device as claimed in claim 1, wherein said scan driver is coupled to said first set of said scan lines at a first side of said plurality of said pixel circuits, and is coupled to said second set of said scan lines at a second side of said plurality of said pixel circuits opposite to said first side.
